(19) United States
(12) Patent Application Publication
(10) Pub. No.: US 2014/0268878 A1
(43) Pub. Date: Sep. 18, 2014

(54) Backlight Module Having Light Guide Plate Positioning Structure

(71) Applicant: BriView Corporation, Taoyuan (TW)

(72) Inventor: Shih-Chun Tseng, Taoyuan (TW)

(73) Assignee: BriView Corporation, Taoyuan (TW)

(21) Appl. No.: 14/214,339

(22) Filed: Mar. 14, 2014

(30) Foreign Application Priority Data
Mar. 15, 2013 (TW) 102109268

(51) Int. Cl. F21V 17/10; F21V 8/00

(52) U.S. Cl. CPC F21V 17/10; G02B 6/0011
USPC 362/615

(57) ABSTRACT

A backlight module includes a light guide plate, a frame, and a positioning pad. The frame includes a sidewall and a tongue plate extending from the sidewall. The sidewall encircles to form an accommodation space. The tongue plate includes an root end connected to the sidewall and a free end bent outwardly with respect to the sidewall. The positioning pad is bent along with the tongue plate and at least partially attaches to an inner surface of the tongue plate. The light guide plate is disposed in the accommodation space and touches the positioning pad.

### BACKGROUND OF THE INVENTION

1. Field of the Invention

The present invention relates to a backlight module; particularly, the present invention relates to a frame of the backlight module having a tongue plate bent outwardly.

2. Description of the Prior Art

In the process of assembling a display device, it is more important for assembling a backlight module. The structural stability and display effect will be affected by the assembling quality of the backlight module. For positioning a light guide plate, one method utilizes a positioning rod to position the light guide plate; another method utilizes plastic pieces to position the light guide plate based on the shape of the light guide plate. The influence of different positioning methods on the display device is described below.

FIG. 1A is a top view of a traditional backlight module. As shown in FIG. 1A, positioning rods 30 are fixed around a light guide plate 20 of a backlight module 10. In this method, an edge where the light guide plate 20 surrounds the positioning rods 30 is a nonlinear shape. Compared to the edge having a linear shape, the nonlinear shape will generate different reflection effect and non-uniform light distribution that will result in poor display quality. Besides, gaps appear between positioning rods 30 and the nonlinear shaped edge of the light guide plate 20. These gaps are the space preserved for assembling tolerance and thermal expansion of the light guide plate 20, but will cause shakiness of the backlight module 10 and generate abnormal sounds.

FIG. 1B is a cross-sectional view of another traditional backlight module. As shown in FIG. 1B, plastic pieces 40 are attached to sidewalls of a frame 50 to improve the shaking of the backlight module 10 caused by gaps. In order to avoid the backlight module 10 from shakiness after the light guide plate 20 is put in the frame 50, a width (w) between inner surfaces 42 of plastic pieces 40 should be smaller than a width (d) of the light guide plate 20. However, in the configuration shown in FIG. 2B, plastic pieces 40 will interfere with the light guide plate 20 in the horizontal direction. Plastic pieces 40 will obstruct the assembling path of the light guide plate 20 when the light guide plate 20 is put in the frame 50. Besides, plastic pieces 40 may be departed from the frame 50 when the light guide plate 20 is put downward and presses an top end of plastic pieces 40.

FIG. 1C is a top view of another traditional backlight module. As shown in FIG. 1C, plastic pieces 40 are disposed around the light guide plate 20 of a backlight module 10. A gap should be kept between plastic pieces 40 and the light guide plate 20, in order to avoid plastic pieces 40 from interfering with the light guide plate 20 and from obstructing the space for assembling the light guide plate 20 after plastic pieces 40 become inflated. However, this method will result in poor fixation because the size of the gap is not easily controlled or because the inflation property of plastic pieces 40 is growing worse as time goes by.

### SUMMARY OF THE INVENTION

It is an object of the present invention to provide an everted tongue plate formed on a frame of a backlight module and a positioning pad attached to the tongue plate to facilitate assembling.

It is another object of the present invention to compact a light guide plate by the positioning pad so as to decrease light leakage possibility.

A backlight module of the present invention is provided. The backlight module includes a light guide plate, a frame, and a positioning pad. The frame includes a sidewall and a tongue plate extending from the sidewall. The sidewall encircles to form an accommodation space. The tongue plate includes an root end connected to the sidewall and a free end bent outwardly with respect to the sidewall. The positioning pad is bent along with the tongue plate and at least partially attaches to an inner surface of the tongue plate. The light guide plate is disposed in the accommodation space and touches the positioning pad. The tongue plate and the position pad not only facilitate the assembly of the light guide plate, but also provide a better clamping effect to increase stability of the whole structure.

### BRIEF DESCRIPTION OF THE DRAWINGS

FIG. 1A is a top view of a traditional backlight module;

FIG. 1B is a cross-sectional view of another traditional backlight module;

FIG. 1C is a top view of another traditional backlight module;

FIG. 2A is a schematic view of an embodiment of a frame of the present invention;

FIG. 2B is a cross-sectional view of an embodiment of a backlight module of the present invention;

FIG. 3A is a schematic view of the frame having a protruding portion;

FIG. 3B is a top view of the frame shown in FIG. 3A;

FIG. 3C is a cross-sectional view of the backlight module adopting the frame shown in FIG. 3A;

FIG. 4A is a schematic view of the frame having a retreated portion;

FIG. 4B is a top view of the frame shown in FIG. 4A; and

FIG. 4C is a cross-sectional view of the backlight module adopting the frame shown in FIG. 4A.

### DETAILED DESCRIPTION OF THE PREFERRED EMBODIMENT

A backlight module of the present invention is provided. The backlight module has an everted tongue plate design to facilitate the assembly of a light guide plate with a frame. In a preferred embodiment, the backlight module is preferably utilized in flat display devices, such as liquid crystal display devices.

FIG. 2A is a schematic view of an embodiment of a frame 200 of the present invention. As shown in FIG. 2A, the frame 200 includes a sidewall 202 and a tongue plate 206 extending outwardly from the sidewall 202. In a preferred embodiment, the frame 200 is a back plate of the whole backlight module or an individual frame. Besides, the frame 200 is preferably made of a metal plate and has a bottom plate 203. The sidewall 202 encircles to form an accommodation space 204 to accommodate the light guide plate 400, a light source (not shown), and other elements. In this embodiment, a bottom end of the sidewall 202 is connected to the periphery of the bottom plate 203. The sidewall 202 and the bottom plate 203 together form the accommodation space 204.

As shown in FIG. 2A, a U-shaped notch 214 is formed on the sidewall 202 in a direction vertical to the horizontal plane. The tongue plate 206 is disposed in the notch 214 and extends from the notch 214 along a light emitting direction before being bent outwardly. The tongue plate 206 includes a root end 208 connected to the sidewall 202 and a free end 210 bent outwardly with respect to the sidewall 202. In other words, the tongue plate 206 and the sidewall 202 are formed as an integral unit. The tongue plate 206 is formed in a stamping manner by cutting a part of the sidewall 202 at a selected position thereof and bending the cutting part. Please refer to FIG. 2B; FIG. 2B is a cross-sectional view of an embodiment of a backlight module 100 of the present invention. As shown in FIG. 2B, in addition to the aforementioned frame 200, the backlight module 100 includes the light guide plate 400 disposed in the accommodation space 204. A positioning pad 300 is attached to an inner surface 212 of the tongue plate 206 of the frame 200. The positioning pad 300 is bent along with the tongue plate 206 and touches an end portion 402 of the light guide plate 400.

Specifically, the positioning pad 300 includes a guiding portion 302 and a clamp portion 304. The guiding portion 302 is attached to and bent along with the tongue plate 206. The clamp portion 304 extends downward from the guiding portion 302 and is attached to the sidewall 202 at a lower part of the root end 208. The clamp portion 304 means the part that substantially touches the end portion 402 of the light guide plate 400 after the light guide plate 400 is assembled; the guiding portion 302 is the part above the clamp portion 304 for guiding the light guide plate 400 into the accommodation space 204. In this embodiment, the clamp portion 304 and the guiding portion 302 are the lower part and the upper part of the positioning pad 300, respectively, and have the same thickness before the light guide plate 400 is put in the accommodation space 204. However, in other embodiments, the thickness of the clamp portion 304 and the guiding portion 302 can be different to increase the clamping effect or the guiding effect. The positioning pad 300 can be adjusted by increasing the curvature. In this embodiment, the positioning pad 300 is attached to a part of the inner surface 212 from upper part of the tongue plate 206 with one end aligned with the free end 210. However, in other embodiments, the position of the positioning pad 300 can be adjusted based on the assembling requirement. For example, if the light guide plate 400 is disposed closer to a bottom surface of the frame 200, the attaching position of the positioning pad 300 can be moved downward accordingly or the attaching length of the positioning pad 300 can be increased downwardly.

The material of the positioning pad 300 can be rubber, conductive foam, or other compressible materials. Thus, the flexibility of the positioning pad 300 is larger than the frame 200, i.e. the positioning pad 300 has a smaller elastic coefficient or a larger restitution coefficient. In other words, the end portion 402 of the light guide plate 400 can compress the clamp portions 304 at two sides when the light guide plate 400 is put into the frame 200. As shown in FIG. 2B, the volume of the positioning pad 300 is reduced after the light guide plate 400 is put into the frame 200; contacting surfaces are pressed toward the tongue plates 206 at two sides from the original position (shown in broken line) and attached closely to the end portion 402 of the light guide plate 400.

On the other hand, a top end 308 of the contacting surface 306 is bent outwardly to form a curve shape. Therefore, the distance L1 between the top end 308 and the inner surface 212 of the tongue plate 206 in a direction parallel to the light guide plate 400 is smaller than the distance L2 between the end portion 402 of the light guide plate 400 and the inner surface 212 of the tongue plate 206. In this embodiment, the tangent of the inner surface 212 approaching to the top end 308 is deflected outwardly at an angle against the vertical line, but not limited to the way shown in FIG. 2B. In other embodiments, the everted degree of the tongue plate 206 can be adjusted based on the material of the positioning pad 300 or the width (d) of the light guide plate 400. With the everted design of the tongue plate 206, the light guide plate 400 can be put into the frame 200 along the curved surface, and then the end portion 402 of the light guide plate 400 can be touched by the positioning pad 300 having flexibility so as to increase convenience of assembling.

Besides, the vertical height between the root end 208 and the free end 210, and the vertical height of the clamp portion 304 will be changed when the tongue plate 206 is bent outwardly. Taking the positioning pad 300 shown in FIG. 2B as an example, the height (H2) of the clamp portion 304 is preferably larger than half thickness (h) of the light guide plate 400. For the tongue plate 206, the height (H1) between the root portion 208 and a top surface 404 of the light guide plate 400 is smaller than half thickness (h) of the light guide plate 400 i.e. the horizontal line above the root portion 208 is higher than the position of half thickness (h) of the light guide plate 400. As such, the positioning pad 300 and the tongue plate 206 would prevent the light guide plate 400 from escaping upwardly and have a better clamping effect.

As shown in FIG. 2B, a pair of the tongue plate 206 and the positioning pad 300 is respectively disposed corresponding to two end portions 402 of the light guide plate 400. The width (d) between two end portions 402 of the light guide plate 400 is not smaller than the distance (W2) between the positioning pads 300 on two sides before compressed, and the width (d) is smaller than the width (W1) between the top portions of two positioning pads 300. The aforementioned distance (W2) refers to the width between a bottom portion of an inner surface of two positioning pads 300 before the light guide plate 400 is put in the frame. By this design, it will ensure two end portions 402 of the light guide plate 400 can touch against the positioning pads 300. The light guide plate 400 is stably fixed in the frame 200 by the close contact between the positioning pad 300 and the light guide plate 400.

In addition to the embodiments shown in FIGS. 2A and 2B, the frame 200 can be adjusted based on the thickness of the positioning pad 300. FIG. 3A is a schematic view of the frame having a protruding portion. As shown in FIG. 3A, the sidewall 202 has a U-shaped notch 214 formed in a direction vertical to the horizontal plane. The tongue plate 206 is disposed in the notch 214 and extends from the notch 214 along a light emitting direction before being bent outwardly. A breach region 215 is formed on the sidewall 202 under the root end 208. A part of the sidewall 202 connected to the tongue plate 206 protrudes outward with respect to the other part of the sidewall 202 by a protruding distance to form a protruding portion. Please refer to FIG. 3B; as shown in the top view of FIG. 3B, the tongue plate 206 shifts outwardly from the inner surface of the sidewall 202 to have a protruding distance (a).

FIG. 3C is a cross-sectional view of the backlight module adopting the frame of shown in FIG. 3A. As shown in FIG. 3C, the tongue plate 206 is translated outwardly with respect to the sidewall 202 (i.e. the direction away from the accommodation space 204). As such, the structure in this embodiment is more suitable for the positioning pad 300 having a larger thickness or being made from compressible material having a larger elasticity coefficient. As mentioned above, for the width at two sides, a pair of the tongue plate 206 and the positioning pad 300 is respectively disposed corresponding to two end portions 402 of the light guide plate 400. The width (d) between two end portions 402 of the light guide plate 400 is not smaller than the distance (W2) between the positioning pads 300 at two sides before compressed, and the width (d) is smaller than the width (W1) between the top portions of the two positioning pads 300. In this embodiment, because the tongue plate 206 protrudes outward, the thickness of the positioning pad 300 is not smaller than the protruding distance. As such, it will ensure two end portions 402 of the light guide plate 400 can touch against the positioning pads 300.

The frame 200 shown in FIG. 4A can be adopted when the positioning pad 300 has a smaller thickness, or when the positioning pad 300 is made from compressible materials having a smaller elasticity coefficient. FIG. 4A is a schematic view of the frame having a retreated portion. As shown in FIG. 4A, the frame 200 has the sidewall 202 and the tongue plate 206 extending from the sidewall 202. The sidewall 202 has a U-shaped notch 214 formed in a direction vertical to the horizontal plane. The tongue plate 206 is disposed in the notch 214 and extends from the notch 214 along a light emitting direction before being bent outwardly. The tongue plate 206 is formed by cutting a part of the sidewall 202 to have the root end 208 and the free end 210 that is bent outwardly with respect to the sidewall 202. A breach region 215 is formed on the sidewall 202 under the root end 208. A part of the sidewall 202 connected to the tongue plate 206 retreats inwardly with respect to the other part of the sidewall 202 (i.e. the direction toward the accommodation space 204) by a retreating distance to form a retreated portion. As shown in the top view of FIG. 4B, the tongue plate 206 shifts inwardly from the inner surface of the sidewall 202 to have a retreating distance (b).

Please refer to FIG. 4C. FIG. 4C is a cross-sectional view of the backlight module adopting the frame of shown in FIG. 4A. As shown in FIG. 4C, the tongue plate 206 moves inwardly with respect to the sidewall 202. As such, the structure in this embodiment is more suitable for the positioning pad 300 having a smaller thickness. In the previous embodiment of the tongue plate 206 protruding outward, the thickness of the positioning pad 300 is not smaller than the protruding distance. Similarly, in this embodiment, a sum of the retreating distance and the thickness of the positioning pad 300 is not smaller than the distance between the sidewall 202 and the end portion 402 of the light guide plate 400. As such, it will ensure two end portions 402 of the light guide plate 400 can touch against the positioning pad 300. When the width (d) of the light guide plate 400 is larger than the distance (W2) between the positioning pads 300 at two sides before the positioning pads 300 are compressed, compared to the traditional frame having no everted structure that will cause the positioning pad interferes with the light guide plate, the present invention utilizes the everted tongue plate 206 and the positioning pad 300 will be bent along with the tongue plate 206. As such, the width (W1) between top ends 308 of two positioning pads 300 is larger than the width (d) of the light guide plate 400 that will prevent the light guide plate 400 from pressing the top end 308 of the positioning pad 300 and will avoid the positioning pad 300 departing from the tongue plate 206 by a downward sheer force while assembling the light guide plate 400. Besides, the curve-shaped positioning pad 300 can guide the light guide plate 400 for assembling.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A backlight module, comprising:
a frame including a sidewall and at least a tongue plate extending from the sidewall, wherein the sidewall encircles to form an accommodation space, the tongue plate includes a root end and a free end, the root end connects to the sidewall, the free end is bent outwardly with respect to the sidewall;
a positioning pad at least partially attached to an inner surface of the tongue plate and bent along with the tongue plate; and
a light guide plate disposed in the accommodation space, wherein an end portion of the light guide plate touches against the positioning pad.

2. The backlight module of claim 1, wherein the elastic coefficient of the positioning pad is smaller than the elastic coefficient of the frame.

3. The backlight module of claim 1, wherein the positioning pad comprises a guiding portion and a clamp portion, the guiding portion is attached to and bent along with the tongue plate, the clamp portion is attached to the sidewall at a lower part of the root end and touches the end portion of the light guide plate.

4. The backlight module of claim 3, wherein the height of the clamp portion is larger than half thickness of the light guide plate.

5. The backlight module of claim 1, wherein the distance between the root portion and a top surface of the light guide plate in a direction vertical to the light guide plate is smaller than half thickness of the light guide plate.

6. The backlight module of claim 1, wherein the end portion of the light guide plate compresses the volume of the positioning pad in a direction toward the sidewall.

7. The backlight module of claim 6, wherein the positioning pad comprises a contacting surface touching the end portion of the light guide plate, a top end of the contacting surface is bent along with the tongue plate, the distance between the top end and an inner surface of the sidewall in a direction parallel to the light guide plate is smaller than the distance between the end portion and the inner surface of the sidewall.

8. The backlight module of claim 1, wherein a notch is formed on the sidewall, the tongue plate is disposed in the notch and extends from the notch along a light emitting direction before being bent outwardly.

9. The backlight module of claim 8, wherein the tongue plate is formed by cutting a part of the sidewall.

10. The backlight module of claim 1, wherein a part of the sidewall connected to the tongue plate protrudes outward with respect to the other part of the sidewall by a protruding distance to form a protruding portion, the thickness of the positioning pad is not smaller than the protruding distance.

11. The backlight module of claim 1, wherein a part of the sidewall connected to the tongue plate retreats inward with respect to the other part of the sidewall by a retreating distance to form a retreated portion, a sum of the retreating distance and the thickness of the positioning pad is not smaller than the distance between the sidewall and the end portion of the light guide plate.

12. The backlight module of claim 1, wherein a pair of the tongue plate and the positioning pad is respectively disposed corresponding to two end portions of the light guide plate, the width between two end portions of the light guide plate is not smaller than the width between a bottom portion of an inner surface of two positioning pads, the width between two end portions of the light guide plate is smaller than the width between a top portion of the inner surface of two positioning pads.

13. The backlight module of claim 1, where a breach region is formed on the sidewall under the root end.
